(19) United States
(12) Patent Application Publication
(10) Pub. No.: US 2008/0180695 A1
(43) Pub. Date: Jul. 31, 2008

(54) Unevenness elimination end-point detecting apparatus and unevenness elimination end-point detecting method for CMP apparatus

(75) Inventors: Takashi Komiyama, Tokyo (JP); Toshiyuki Yokoyama, Tokyo (JP)

Correspondence Address: PAUL A. FATTIBENE;FATTIBENE & FATTIBENE, 2480 POST ROAD, SOUTHPORT, CT, 06890, US

(73) Assignee: TOKYO SEIMITSU CO., LTD.

(21) Appl. No.: 11/986,944

(22) Filed: Nov. 27, 2007

(30) Foreign Application Priority Data
Jan. 26, 2007 (JP) 2007-017179

(51) Int. Cl. G01B 11/24; B24B 49/12

(52) U.S. Cl. 356/612; 451/6

(57) ABSTRACT

An unevenness elimination end-point detection apparatus for a CMP apparatus which polishes a film to be polished formed on a wafer surface includes: light irradiation means for irradiating a light on a polishing surface of the wafer during polishing of the wafer; photoelectric conversion means for converting a light intensity of a reflected light from the polishing surface into an electric signal to output the electric signal as a light intensity signal; and determination means for determining an elimination end-point of the initial unevenness of the wafer on the basis of the light intensity signal output from the photoelectric conversion means. The irradiated light is white light and the white light is split and input to the photoelectric conversion means, and light intensity signals are output in units of wavelengths of split lights. In this manner, an elimination end-point of the initial unevenness can be optically detected during wafer polishing.

### BACKGROUND OF THE INVENTION

1. Field of the Invention

The present invention relates to an unevenness elimination end-point detecting apparatus and an unevenness elimination end-point detecting method for a CMP apparatus and, more particular, to an unevenness elimination end-point detecting apparatus and an unevenness elimination end-point detecting method for a CMP apparatus which optically detect an end-point at which an initial unevenness of a wafer is canceled during polishing of the initial unevenness.

2. Description of the Related Art

In a conventional technique, when a film to be polished such as a metal film or an oxide film on a wafer surface is to be flatly polished by a CMP of this type, the wafer is pressed against a polishing pad with a predetermined pressure, and a polishing agent is supplied onto an upper surface of the polishing pad while rotating the polishing pad and the wafer to polish the film to be polished.

FIG. 7 shows a wafer W having a surface on which a Cu film is formed as a film to be polished. As shown in FIG. 7, a barrier film 4 such as a Ta film is formed in a trench 3 formed in the oxide film 2 on an Si substrate 1. Furthermore, a film to be polished 5 which is a Cu film is formed on the barrier film 4. The surface of the film to be polished 5 is not a perfectly flat surface. In particular, an initial unevenness (level difference) 6 is formed on a surface corresponding to the trench 3.

When the wafer W is to be polished by the CMP apparatus, a CMP process is generally executed in two steps, i.e., a rough polishing step and a finish polishing step. More specifically, as a first polishing step, rough polishing (initial polishing) is performed to eliminate the initial unevenness 6. Thereafter, as a second polishing step, finish polishing is performed up to a polishing end-point (including an end-point at which a predetermined film thickness is obtained) at which a final polishing surface becomes flat. In transition from the rough polishing to the finish polishing, polishing conditions such as a polishing rate, a polishing pressure, and a polishing agent are changed depending on the finish polishing, in terms of improvement of polishing efficiency, saving of running cost, and the like (for example, see Patent Document 1).

[Patent Document 1] Japanese Patent Application Laid-Open No. 2003-31577

In the conventional CMP apparatus, a polishing end-point in the finish polishing step is optically detected (including detection of a film thickness), so that a stop point of a terminal finish polishing process can be accurately recognized. However, since there is no means for detecting an elimination end-point of an initial unevenness in rough polishing, the elimination point of the initial unevenness cannot be recognized during the rough polishing.

At the present, at a site for polishing, an operator uses a seat-of-the-pants approach to estimate the elimination end-point of the initial unevenness by the trial-and-error method. The operator changes the polishing conditions when the elimination end-point is estimated. At a result, the time when the elimination end-point of the initial unevenness is estimated is not always accurately equal to time when the polishing conditions are changed. More specifically, the polishing conditions are frequently changed before or after the initial unevenness is eliminated.

In the conventional CMP, the time when the polishing conditions are changed is not the same as the time of the elimination end-point of the initial unevenness. For this reason, deterioration of polishing efficiency of a wafer, a rapid increase in running cost (waste of a polishing agent), and a decrease in yield of wafers are disadvantageously caused.

### SUMMARY OF THE INVENTION

Therefore, a technical problem is posed, that is to be solved to accurately recognize an elimination end-point of an initial unevenness of a wafer polishing surface, improve polishing efficiency, save the running cost, and increase an yield of wafers. The present invention has its object to solve the above problem.

The present invention has been proposed to achieve the above object, and according to a first aspect of the invention, there is provided an unevenness elimination end-point detection apparatus for a CMP apparatus which changes polishing conditions after a film to be polished on a wafer surface having an initial unevenness is roughly polished to perform finish polishing, the apparatus including: light irradiation means for irradiating a light on a polishing surface of the wafer during polishing of an initial unevenness of the wafer; photoelectric conversion means for receiving a reflected light from the polishing surface of the wafer and converting a light intensity of the reflected light into an electric signal to output the electric signal as a light intensity signal; and determination means for determining an elimination end-point of the initial unevenness of the wafer on the basis of the light intensity signal output from the photoelectric conversion means, wherein an elimination end-point of the initial unevenness is detected during the polishing of the wafer.

With the configuration, a light is irradiated on the polishing surface of the wafer by the light irradiation means, a light reflected by the polishing surface of the wafer is received by the photoelectric conversion means, and a light intensity of the reflected light is converted into an electric signal. The electric signal is output to the determination means as a light intensity signal, and an elimination end-point of an initial unevenness of the wafer is detected on the basis of the light intensity signal. Therefore, when the elimination end-point of the initial unevenness is detected, polishing conditions such as a polishing rate, a polishing pressure, and a type of a polishing agent are changed. Thereafter, a CMP process is continued up to an end-point of finish polishing of the wafer.

According to a second aspect of the invention, there is provided the unevenness elimination end-point detection apparatus for a CMP apparatus, wherein the light irradiated on the polishing surface of the wafer is white light and the white light is split and input to the photoelectric conversion means, and the photoelectric conversion means outputs light intensity signals in units of wavelengths of split lights.

With the configuration, white light is irradiated on the polishing surface of the wafer to reflect the white light, the reflected light is split into lights in units of predetermined wavelengths, and light intensity signals having the wavelengths are output by the photoelectric conversion means. On the basis of the light intensity signals having the different wavelengths, the determination means determines an elimination end-point of the initial unevenness of the wafer. Therefore, since the white light includes light of all color components, light intensity data of a wavelength region of the light of all the color components can be obtained.

According to a third aspect of the invention, there is provided the unevenness elimination end-point detection apparatus for a CMP apparatus, wherein the photoelectric conversion means integrates light intensities in a wavelength region having a predetermined width to output a light intensity signal.

With the configuration, the light intensities of the reflected lights are integrated in a wavelength region having a predetermined width, and the lights are converted into electric signals on the basis of the integral value to output light intensity signals. Therefore, the light intensity signals amplified by an integrated value are output from the photoelectric conversion means to the determination means.

According to a fourth aspect of the present invention, there is provided the unevenness elimination end-point detection apparatus for a CMP apparatus, wherein the determination means quantitatively determines the degree of elimination of the initial unevenness of the wafer depending on magnitudes of the light intensity signals during the polishing of the wafer.

With the configuration, with the progress of polishing of the wafer, the degree of initial unevenness of the wafer, i.e., the degree of unevenness of the surface to be polished decreases. Accordingly, an amount of reflected light increases. As a result, the light intensity signal output from the photoelectric conversion means increases depending on an increase in amount of reflected light. In this manner, depending on the magnitude (strong or weak) of the light intensity signal, the degree of elimination of the initial unevenness is quantitatively determined by the determination means. Therefore, an elimination state of the initial unevenness with the progress of rough polishing is quantitatively recognized.

According to a fifth aspect of the present invention, there is provided an unevenness elimination end-point detection method for a CMP apparatus which changes polishing conditions after a film to be polished on a wafer surface having an initial unevenness is roughly polished to perform finish polishing, the method including: a light irradiation step of irradiating a light on a polishing surface of the wafer during polishing of an initial unevenness of the wafer; a photoelectric conversion step of receiving a reflected light from the polishing surface of the wafer and converting a light intensity of the reflected light into an electric signal to output the electric signal as a light intensity signal; and a determination step of determining an elimination end-point of the initial unevenness of the wafer on the basis of the light intensity signal output from the photoelectric conversion means, wherein an elimination end-point of the initial unevenness is detected during the polishing of the wafer.

According to the method, a light is irradiated on the polishing surface of the wafer by light irradiation means, a light reflected by the polishing surface of the wafer is received by photoelectric conversion means, and a light intensity of the reflected light is converted into an electric signal. The electric signal is output to determination means as a light intensity signal, and an elimination end-point of an initial unevenness of the wafer is detected on the basis of the light intensity signal. Therefore, when the elimination end-point of the initial unevenness is detected, polishing conditions such as a polishing rate, a polishing pressure, and a type of a polishing agent are changed, and a CMP process is continued up to an end-point of finish polishing of the wafer.

The electric signal output as the light intensity signal changes in magnitude (strong or weak) depending on the degree of elimination of the initial unevenness with the progress of polishing, and the initial unevenness is eliminate to generate a changing point. A point of time at which the changing point is detected is defined as an immediate polishing end-point. The time of point when polishing is performed by a predetermined amount after the changing point is detected is determined as an end-point to obtain an appropriate end-point.

Depending on the degree of elimination of the initial unevenness with the progress of polishing, the magnitude (strong or weak) changes, and the initial unevenness is eliminated. Before or after the changing point has come, a point of time when a stage where the light intensity signal reaches a threshold is detected, is defined as an immediate end-point. Furthermore, the point of time when polishing is performed by a predetermined amount from the threshold is defined as the end-point to make it possible to obtain an appropriate polishing end-point.

According to the first aspect, an elimination end-point of the initial unevenness of the wafer can be accurately detected, and polishing conditions such as a polishing rate and a polishing agent can be changed at a timing corresponding to the elimination end-point. For this reason, consumption articles such as a polishing agent can be prevented from being wasted to make it possible to save the running cost, and polishing efficiency can be improved. Since the polishing conditions are changed at an optimum timing to make it possible to improve control of flatness of the wafer polishing surface, the number of defective products decreases to obtain an yield of wafers higher than a conventional yield.

According to the second aspect, on the basis of light intensity signals of different frequencies obtained by splitting white light including all color components, an elimination end-point of an initial unevenness of a wafer can be determined. For this reason, in addition to the effect of the invention according to the first aspect, a large number of light intensity data of different frequencies can be collected over a wide-range region, and a light intensity signal of a frequency suitable for a type of a film to be polished of the wafer can be analyzed in detail, so that an elimination end-point of an initial unevenness can be more accurately detected.

According to the third aspect, a light intensity signal of a reflected light amplified in a wavelength region having a predetermined width is output to determination means. Therefore, in addition to the effects of the inventions according to the first and second aspects, an elimination end-point of an initial unevenness can be more accurately detected on the basis of the light intensity signal amplified by the determination means. Even though an amount of irradiated light is decreased, the elimination end-point of the initial unevenness can be reliably detected.

According to the fourth aspect, the degree of initial unevenness can be quantitatively determined depending on the magnitude of a light intensity signal of a reflected light. Therefore, in addition to the effect of the invention according to the first, second, or third aspect, not only detection of an elimination end point (end of flattening) of the initial unevenness, an elimination state of the initial unevenness changing depending on the progress of wafer polishing, i.e., a progress state of flattening by rough polishing can be quantitatively recognized on real time.

According to the fifth aspect, an elimination end-point of an initial unevenness of a wafer can be accurately detected, and polishing conditions such as a polishing rate and a polishing agent can be changed at a timing corresponding to the elimination end-point. For this reason, consumption articles such as a polishing agent can be prevented from being wasted to make it possible to save the running cost, and polishing efficiency can be improved. Furthermore, since the polishing conditions can be performed at an optimum timing to make it possible to improve control of flatness of a wafer polishing surface, the number of defective products decreases to obtain an yield of wafers higher than a conventional yield.

### BRIEF DESCRIPTION OF THE DRAWINGS

FIG. 1 shows an embodiment of the present invention, and is a block diagram showing an unevenness elimination end-point detection apparatus for a CMP apparatus;

FIG. 2 is a diagram for explaining a configuration of a polychrometer according to the embodiment;

FIG. 3 is a graph exemplifying a light intensity distribution according to the embodiment;

FIG. 4 is a sectional view showing a wafer on which an unevenness elimination end-point is to be detected according to the embodiment;

FIG. 5 is a flow chart for explaining procedures of unevenness elimination end-point detection according to the embodiment;

FIG. 6 is a graph exemplifying a distribution of reflected lights according to the embodiment;

FIG. 7 is a sectional view showing a wafer to be polished by a CMP apparatus; and

FIG. 8 is a graph exemplifying a relationship between a light intensity and an unevenness of a wafer according to the embodiment.

### DESCRIPTION OF THE PREFERRED EMBODIMENTS

The present invention provides an unevenness elimination end-point detection apparatus for a CMP apparatus which can accurately recognize an elimination end-point of an initial unevenness of a wafer in a CMP process and performs finish polishing while changing polishing conditions after a film to be polished on a wafer surface having an initial unevenness is roughly polished to achieve objects of improving polishing efficiency of a wafer, saving the running cost, and increasing an yield. The unevenness elimination end-point detection apparatus includes: light irradiation means for irradiating a light on a polishing surface of the wafer during polishing of the initial unevenness of the wafer; photoelectric conversion means for receiving a reflected light from the polishing surface of the wafer and converting a light intensity of the reflected light into an electric signal to output the electric signal as a light intensity signal; and determination means for determining an elimination end-point of the initial unevenness of the wafer on the basis of the light intensity signal output from the photoelectric conversion means to make it possible to detect an elimination end-point of the initial unevenness during polishing of the wafer.

A preferred embodiment of the present invention will be described below with reference to FIGS. 1 to 8. This embodiment is applied to a CMP apparatus which uses a wafer on which a film (metal film, oxide film, or the like) to be polished having an initial unevenness is formed as an object to be polished and gradually polishes the wafer in two polishing steps constituted by rough polishing and finish polishing. The embodiment includes a step of performing rough polishing (initial polishing) until an initial unevenness is eliminated as a first polishing step, and a step of performing finish polishing up to a polishing end-point at which a final polishing surface is flat as a second polishing step.

In transition from rough polishing to finish polishing, polishing conditions such as a polishing rate, a polishing pressure, and a polishing agent are changed depending on the finish polishing to improve polishing efficiency and to save the running cost. The CMP apparatus according to the embodiment can quantitatively monitor and determine the degree of unevenness of the initial unevenness changing with the progress of rough polishing of the wafer and to make it possible to detect an unevenness elimination end-point at which the unevenness is flattened in line.

FIG. 1 is a block diagram showing a configuration of an unevenness elimination end-point detection apparatus 11 of a CMP apparatus 10 according to the present invention. In FIG. 1, the CMP apparatus 10 is constituted by a disk-like platen 12, a polishing pad 13, a vertically movable wafer holding head 14, a supply nozzle 15 and a control unit 16. The disk-like platen 12 is driven by a motor (not shown) to horizontally rotate. The polishing pad 13 is fastened on the surface of the disk-like platen 12. The vertically movable wafer holding head 14 holds a wafer W to bring the wafer W into contact with the polishing pad 13 with a predetermined pressure. The supply nozzle 15 supplies a polishing agent (slurry) onto the surface of the polishing pad 13. The control unit 16 controls driving of the entire CMP apparatus 10.

An observation hole 17 is formed at a predetermined position of the disk-like platen 12 to penetrate the disk-like platen 12, and an observation window 18 made of a transparent material is fitted in an upper-end opening of the observation hole 17. The wafer holding head 14 presses the wafer W against the polishing pad 13 at a position decentered from the center of rotation of the disk-like platen 12, and is driven by a motor (not shown) to horizontally rotate. When the wafer W is to be polished, the wafer W is pressed against the polishing pad 13 with a predetermined pressure and polished while being rotated together with the polishing pad 13 such that the polishing agent is supplied from the supply nozzle 15 onto the upper surface of the polishing pad 13.

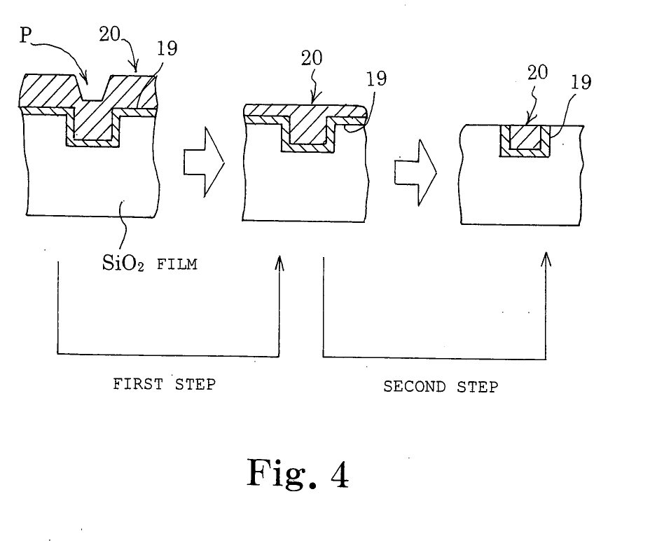

The unevenness elimination end-point detection apparatus 11 included in the CMP apparatus 10 optically detects a point of time when an unevenness (step) is eliminated on the polishing surface of the film to be polished 20 (see FIG. 4) with the progress of polishing, i.e., an elimination end-point of the initial unevenness.

The unevenness elimination end-point detection apparatus 11 is constituted by a light source 21, an irradiated light-receiving unit 22, a polychrometer 23, a two-split light guide (waveguide) 24, and a computer 25. The light source 21 serves as light irradiation means for emitting white light. The irradiated light-receiving unit 22 derives the light from the light source 21 to the polishing surface of the wafer W to irradiate the light on the polishing surface of the wafer W and receives reflected light from the polishing surface of the wafer W. The polychrometer 23 splits the reflected light received by the irradiated light-receiving unit 22. The two-split light guide (waveguide) 24 is arranged between both the polychrometer 23 and the light source 21 and the irradiated light-receiving unit 22. The computer 25 analyzes data of reflected light input through the two-split light guide 24.

In the embodiment, the polychrometer 23 serves as light-splitting means and photoelectric conversion means and outputs light intensity signals to the computer 25 in units of wavelengths on the basis of the split reflected lights. The computer 25 functions as determination means for determining an elimination end-point of the initial unevenness of the wafer W on the basis of the light intensify signals output from the polychrometer 23.

In the light source 21, for example, a halogen lamp which emits white light is incorporated. The irradiated light-receiving unit 22 is arranged below the observation hole 17, and is constituted by a lens barrel (not shown) and a condenser lens arranged in the lens barrel.

One end of the two-split light guide 24 obtained by binding a large number of optical fibers is connected to a lower end of the irradiated light-receiving unit 22, and the other end of the two-split light guide 24 is split to an irradiation-side light guide 24A and a receiving-side light guide 24B along the way. The irradiation-side light guide 24A is connected to the light source 21. On the other hand, the receiving-side light guide 24B is connected to the polychrometer 23. The irradiation-side light guide 24A and the light source 21 constitute light-irradiation means.

In the unevenness elimination end-point detection apparatus 11 having the above configuration, the white light emitted from the light source 21 is guided to the irradiated light-receiving unit 22 by the irradiation-side light guide 24A of the two-split light guide 24 and then converged by the condenser lens of the irradiated light-receiving unit 22.

The light passes through the observation window 18 formed in the disk-like platen 12 and is irradiated on a polishing surface (lower surface) of the wafer W on the polishing pad 13. The light reflected by the polishing surface of the wafer W is converged by the condenser lens of the irradiated light-receiving unit 22, derived by the polychrometer 23 through the receiving-side light guide 24B, and split into lights in units of a plurality of wavelengths.

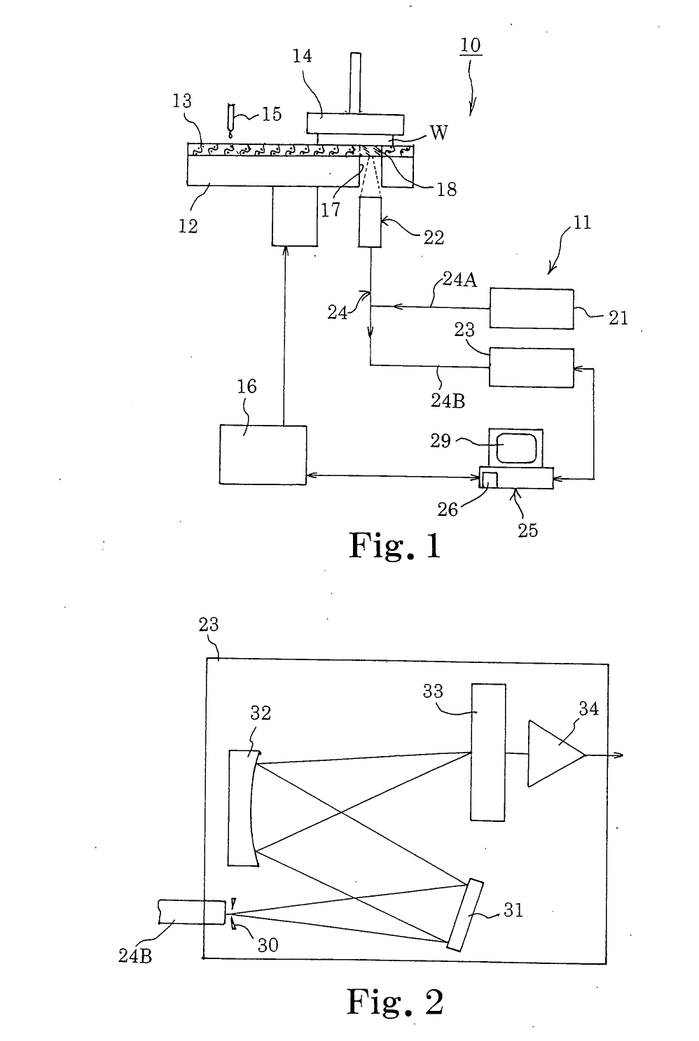

The respective lights split in units of wavelengths by the polychrometer 23 are converted into electric signals depending on optical intensities, and the electric signals are output to the computer 25 as light intensity signals in units of wavelengths. More specifically, the polychrometer 23, as shown in FIG. 2, is constituted by an incident slit 30, a plane mirror 31, a concave diffraction grating 32, an array light-receiving element 33, and a multiplexer 34.

A reflected light guided by the polychrometer 23, as shown in FIG. 2, is guided to the concave diffraction grating 32 by the plane mirror 31 through the incident slit 30 and split by the concave diffraction grating 32 in units of wavelengths. The split lights are focused on the array light-receiving element 33, converted into electric signals depending on light intensities in units of wavelengths, and output to the computer 25 through the multiplexer 34 as light intensity signals of wavelengths.

A determination unit of the computer 25 determines a point of time at which an unevenness is eliminated with the progress of rough polishing, i.e., an elimination end-point of an initial unevenness polished into a uniform flat surface. The principle of the determination uses the following fact. That is, with the decrease of the initial unevenness of the surface of the film to be polished 20 by rough polishing of the wafer W, an amount of reflected light on the surface of the film to be polished 20 increases, and the light intensity signals of the wavelengths increase.

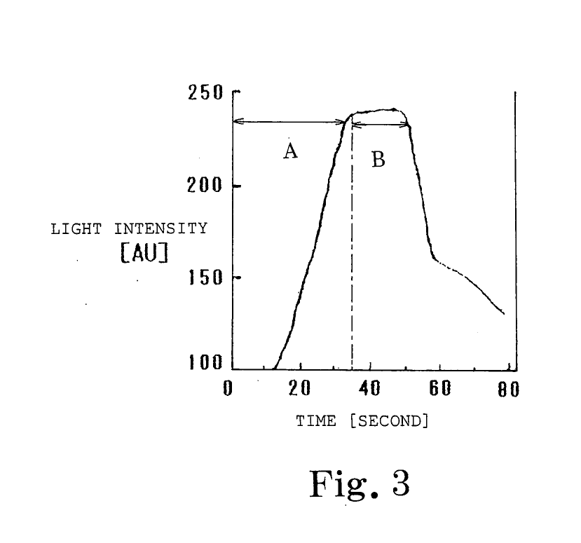

Therefore, with elimination of the initial unevenness on the surface of the film to be polished 20, the light intensity signal of the reflected light increases accordingly. For this reason, as shown in FIG. 3, when the initial unevenness is completely eliminated, the light intensity signal becomes maximum. In this way, the determination unit of the computer 25 executes determination of the elimination end-point of the initial unevenness when the light intensity signal becomes maximum. At the same time, an elimination end-point signal of the initial unevenness is output to the control unit 16 of the CMP apparatus 10. In this manner, the control unit 16 transmits a command signal representing that polishing conditions are changed to drive units of the CMP apparatus 10 to display contents of the change of the polishing conditions on a monitor unit 29 integrated with the computer 25. As polishing conditions, used are, for example, a polishing rate (rotating speed of the polishing head and rotating speed of the platen), a polishing pressure, a type or component of a polishing agent, a temperature of the wafer W, and the like.

The computer 25 arithmetically processes a light intensity signal from the polychrometer 23 according to a predetermined algorithm to detect the elimination end-point of the initial unevenness of the film to be polished 20. Although an example of the algorithm for detecting the unevenness elimination end-point will be described below, the present invention is not limited to the algorithm, and can employ various algorithms for detecting an unevenness elimination end-point.

First, as shown in FIG. 3, a graph of a light intensity distribution expressing changes in light intensity with time in respective specific wavelength regions is created on the basis of a light intensity signal in a specific wavelength region having a large amount of reflected light in a reflectance spectrum. A point of time at which the light intensity is differentiated by time is 0 or an approximate point of time before or after the point of time, i.e., a point of time at which the light intensity is maximum or a point of time approximate to the point of time, is determined as an elimination end-point of the initial unevenness on the film to be polished 20. Reference symbol A in FIG. 3 denotes a zone in which the film to be polished 20 is flattened, and reference symbol B in FIG. 3 denotes a zone in which the film to be polished 20 is polished while being flattened.

According to the unevenness elimination end-point detection apparatus 11, during rough polishing of the wafer W, a reflected light on the polished surface of the wafer W is split into lights in units of wavelengths, and an elimination end-point of the initial unevenness is determined on the basis of a light intensity distribution of the wavelengths of the split lights. In the embodiment, white light is split to output light intensity signals of wavelengths. On the basis of the light intensity signal, an elimination end-point of the initial unevenness of the wafer is determined. Therefore, light intensity data of all color components included in the white light can be collected over a wide wavelength range, and light intensity signals of wavelengths compatible with a type of a film to be polished of a wafer can be closely analyzed to make it possible to accurately detect the elimination end-point of the initial unevenness.

Since introduction of irradiated light and extraction of reflected light are performed by using the irradiation-side light guide 24A and the receiving-side light guide 24B, efficiency of utilization of light is improved to improve a detection intensity.

Procedures for detecting an unevenness elimination end-point will be described in detail. In this case, the wafer W having an end-point to be detected is constituted as shown in FIG. 4. That is, a barrier 19 such as a Ta film is formed in a trench formed in an oxide film on an Si substrate, and the film to be polished 20 which is a Cu film is formed on the barrier 19.

When the film to be polished 20 of the wafer W is to be polished, rough polishing is performed as a first polishing step until an initial unevenness P on the surface of the film to be polished 20 is eliminated. Thereafter, as a second polishing step, finish polishing is performed up to a polishing end-point at which a finish polishing surface is flat.

Polishing of the wafer W includes the step of changing polishing conditions such as a polishing rate, a polishing pressure, and a polishing agent when the elimination end-point of the initial unevenness P on the film to be polished 20 is detected with progress of polishing.

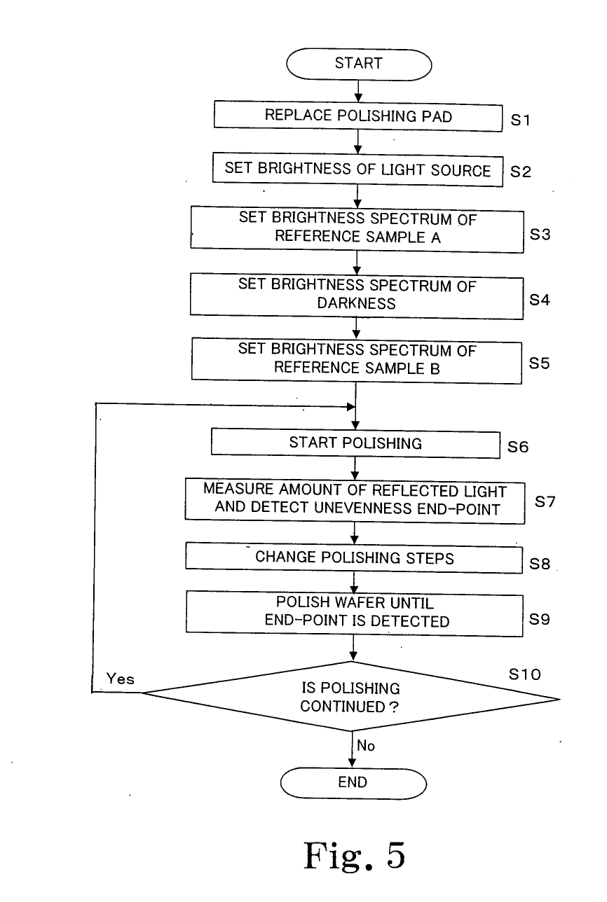

As shown in FIG. 5, in a polishing process in the embodiment, first, the polishing pad 13 is replaced with a new polishing pad 13 (step S1), and a brightness (light intensity) of a light source is set under the conditions corresponding to the new polishing pad 13 (step S2). At this time, a brightness of white light emitted from the light source is represented by L1.

Thereafter, at the set brightness L1, the computer 25 places a reference sample A on the upper surface of the polishing pad 13 as an unevenness-free sample to measure a brightness spectrum. The measured brightness spectrum is set as a measurement reference, i.e., a brightness spectrum R1 and stored in a memory 26 of the computer 25 (step S3).

A darkness will be measured (step S4). The measurement of the darkness is performed such that white light is incident on the observation window 18 of the polishing pad 13 without placing anything on the observation window 18 to measure the brightness spectrum of the reflected light. A measured darkness D1 is stored in the memory 26 of the computer 25. As needed, a sample having an unevenness is placed on the upper surface of the polishing pad 13 as a reference sample B to measure a brightness spectrum. The measured brightness spectrum is set as a measurement reference, i.e., a brightness spectrum R2 and stored in the memory 26 of the computer 25 (step S5).

Thereafter, the wafer W is set on the polishing pad 13 to start rough polishing for the wafer W (step S6). When the rough polishing is started, the unevenness elimination end-point is detected by the above procedures. More specifically, the reflected light of the light irradiated on the polishing surface of the wafer W is split by the polychrometer 23 (splitting means) 23 to measure a brightness spectrum T1 of each of the wavelengths of the respective split lights.

In this manner, on the basis of the brightness spectrum T1 measured during the wafer polishing, the brightness spectrum R1 of the reference sample, and the darkness D1, the computer 25 detects an unevenness elimination end-point (step S7).

More specifically, the darkness D1 is subtracted from each of the brightness spectrum T1 of the wafer W serving as an object to be detected and the brightness spectra R1 and R2 of the reference samples A and B. On the basis of the brightness spectrum T1 and the brightness spectra R1 and R1 which are obtained after the subtraction, a measured reflectance is calculated. When the calculated measured reflectance is maximum, a point of time at which the initial unevenness is eliminated, i.e., an elimination end-point of the initial unevenness is determined.

Time when the unevenness elimination end-point is determined means time when a light intensity signal is maximum in a graph of the light intensity distribution in FIG. 3. When the determination of the unevenness elimination is executed, the computer 25 outputs the unevenness elimination end-point signal to the control unit 16 of the CMP apparatus 10 to change the polishing conditions (step S8).

After the polishing conditions are changed, a polishing process is continuously performed until a final finish polishing surface of the wafer W is flattened, i.e., up to a finish polishing end-point (step S9). It is determined whether the wafer W can be continuously polished. If the wafer W can be polished, the operation flow returns to step S6, otherwise, the operation is ended (step S10).

As described above, according to the embodiment, a reflected light is extracted from the receiving-side light guide 24B, and the brightness spectrum T1 of the wafer W and the brightness spectrum R1 of the reference sample are compared with each other, so that an end-point at which the initial unevenness is eliminated is optically determined.

More specifically, at the beginning of polishing, the surface of the wafer W is uneven. For this reason, light is diffusely reflected by the unevenness, and the reflected light is attenuated by the diffused reflection, so that a total amount of reflected light is small. When the surface of the wafer W is flattened with the progress of wafer polishing, the diffused reflection of light becomes small. For this reason, the amount of reflected light gradually increases, and is maximum when the unevenness is eliminated.

In short, in the embodiment, on the basis of a change of an initial unevenness of a polishing pattern, an amount of reflected light representing the magnitude of the reflectance is detected to optically detect an elimination end-point of the initial unevenness. After the unevenness is eliminated by the rough polishing, the polishing steps are switched to change the polishing conditions.

As described above, according to the present invention, a light intensity of a reflected light from the polishing surface of the wafer W is converted into an electric signal by the photoelectric conversion means, and the electric signal is output as a light intensity signal. The elimination end-point of the initial unevenness of the wafer W is detected on the basis of the light intensity signal. When the elimination end-point of the initial unevenness is detected, the polishing conditions such as a polishing rate, a polishing pressure, and a polishing agent are changed, and a CMP process is continued up to a final finish polishing end-point of the wafer W.

Therefore, since the elimination end-point of the initial unevenness of the wafer W can be accurately detected, a timing at which the polishing conditions such as a polishing rate, a polishing pressure, and a polishing agent should be changed can be made accurately equal to a timing of the elimination end-point of the initial unevenness. Polishing efficiency can be improved, and consumption articles such as a polishing agent can be prevented from being wasted. Furthermore, the flatness of the wafer polishing surface increases in accuracy, and defects such as dishing and erosion can be eliminated. For this reason, the wafer W is improved in quality, and an yield of wafers W is considerably increased in comparison with a conventional technique.

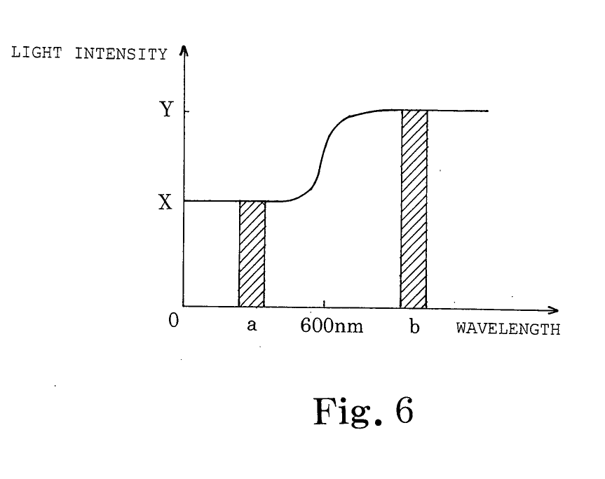

As shown in FIG. 6, light intensities of the reflected lights are integrated by the polychrometer (photoelectric conversion means) 23 in a range of a wavelength region having a predetermined width a or b, and the reflected lights can be amplified into light intensity signals depending on the integrated value and output. In this manner, since the computer (determination means) 25 determines an elimination end-point of the initial unevenness of the wafer W on the basis of the amplified light intensity signals, the elimination end-point of the initial unevenness can be detected at high accuracy.

During the polishing of the wafer w, the light intensity output from the polychrometer 23 increases because an amount of reflected light increases when the degree of unevenness of the initial unevenness of the wafer W decreases. In the embodiment, a light intensity (brightness spectrum) of a reflected light of a wafer having a known initial unevenness is stored in the memory 26 of the computer 25 in advance, and data representing a correlation between the magnitude of the light intensity of the reflected light of the wafer and the degree of unevenness of the initial unevenness is also stored in the memory 26. Therefore, with reference to the known data stored in the memory 26, the strong or weak (large or small) of a light intensity signal obtained during polishing of the wafer W to be polished are compared with each other and evaluated by the determination unit of the computer 25, so that the degree of unevenness of the initial unevenness depending on the magnitude of the light intensity signal can be quantitatively determined.

In this way, not only detection of an elimination end-point (end of flattening) of an initial unevenness, but also continuous and detailed real-time recognition of elimination states of the initial unevenness changing with the progress of polishing of the wafer W, i.e., progressing states of flattening of rough polishing can be performed. In the example shown in the drawings, since the elimination end-point of the initial unevenness and the elimination state of the initial unevenness are always displayed by the monitor unit 29, the progressing state of polishing can be displayed on the screen of the monitor unit 29 and recognized and managed on real time. Data or the like related to the reflected light including the polishing conditions and analysis of a light intensity signal can be displayed by the monitor unit 29 as needed.

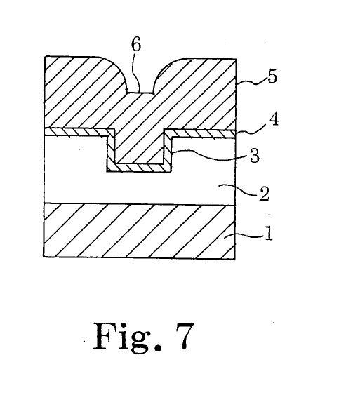

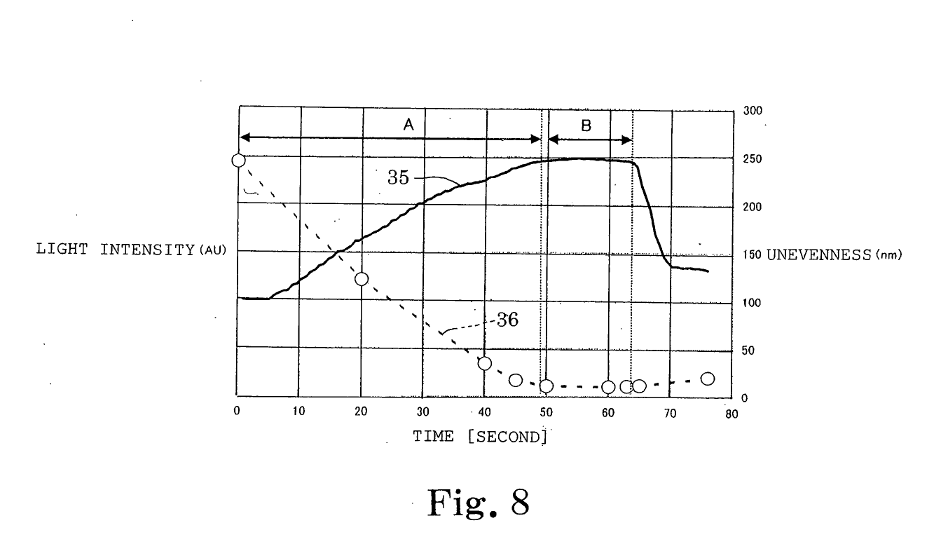

On the basis of the present invention, a wafer W shown in FIG. 7 and having a surface on which a Cu film is formed as a film to be polished was polished without changing the polishing conditions, polishing was stopped at different polishing times in wafers each having the same initial unevenness, and the unevennesses after the polishing were measured. Relationships between the light intensities and the unevennesses are shown in FIG. 8.

A solid line 35 indicates a light intensity, i.e., data of a light intensity signal related to a reflected light displayed on real time by the monitor unit 29. A broken line 36 indicates an unevenness of a wiring layer formed as a typical example with a Cu line width of 50 μm.

In a zone in which the light intensity is maximum, the unevenness is minimum when a change in light intensity appears, and polishing is performed with the minimum unevenness while flattening the film, the light intensity almost constantly changes. In FIG. 8, reference symbol A denotes a zone in which the film to be polished 20 is flattened, and reference symbol B denotes a zone in which the film to be polished 20 is polished while being flattened.

The CMP process according to the present invention performs flattening of a finish polishing surface as the final purpose. However, in this case, a change in thickness of the wafer W is not detected, and an elimination end point of the unevenness of the wafer W is detected. The present invention provides a novel unevenness elimination end-point detection apparatus having an approach scheme completely different from a conventional detection scheme.

Various modifications of the present invention can be effected without departing from the spirit and scope of the present invention, and the present invention covers the modifications, as a matter of course. For example, the same configuration, principle, and operations as described above may be used to apply the present invention to an electrolytic polishing apparatus, an electrolytic machining apparatus, an electrolytic CMP apparatus, a wrapping apparatus, and the like.

Light emitted from a light source is not limited to white light. Light having a wavelength region equal to that of red light or blue light may be used. A laser beam irradiation apparatus or an LED apparatus which irradiates a single monochromatic light or a plurality of monochromatic lights may be employed.

What is claimed is:

1. An unevenness elimination end-point detection apparatus for a CMP apparatus which changes polishing conditions after a film to be polished on a wafer surface having an initial unevenness is roughly polished to perform finish polishing, the apparatus comprising:
light irradiation means for irradiating a light on a polishing surface of the wafer during polishing of an initial unevenness of the wafer;
photoelectric conversion means for receiving a reflected light from the polishing surface of the wafer and converting a light intensity of the reflected light into an electric signal to output the electric signal as a light intensity signal; and
determination means for determining an elimination end-point of the initial unevenness of the wafer on the basis of the light intensity signal output from the photoelectric conversion means, wherein
an elimination end-point of the initial unevenness is detected during the polishing of the wafer.

2. The unevenness elimination end-point detection apparatus for a CMP apparatus according to claim 1, wherein
the light irradiated on the polishing surface of the wafer is white light, and the white light is split and input to the photoelectric conversion means, and
the photoelectric conversion means outputs light intensity signals in units of wavelengths of split lights.

3. The unevenness elimination end-point detection apparatus for a CMP apparatus according to claim 1 or 2, wherein
the photoelectric conversion means integrates light intensities in a wavelength region having a predetermined width to output a light intensity signal.

4. The unevenness elimination end-point detection apparatus for a CMP apparatus according to claim 1 or 2, wherein
the determination means quantitatively determines the degree of elimination of the initial unevenness of the wafer depending on magnitudes of the light intensity signals during the polishing of the wafer.

5. An unevenness elimination end-point detection method for a CMP apparatus which changes polishing conditions after a film to be polished on a wafer surface having an initial unevenness is roughly polished to perform finish polishing, the method comprising:
a light irradiation step of irradiating a light on a polishing surface of the wafer during polishing of an initial unevenness of the wafer;
a photoelectric conversion step of receiving a reflected light from the polishing surface of the wafer and converting a light intensity of the reflected light into an electric signal to output the electric signal as a light intensity signal; and
a determination step of determining an elimination end-point of the initial unevenness of the wafer on the basis of the light intensity signal output from the photoelectric conversion means, wherein
an elimination end-point of the initial unevenness is detected during the polishing of the wafer.
